(19) United States
(12) Patent Application Publication
(10) Pub. No.: US 2026/0264793 A1
(43) Pub. Date: Sep. 10, 2026

(54) MOUNTING ASSEMBLY FOR A BICYCLE

(71) Applicant: MARC MAEDGEN, ROCKWALL, TX (US)

(72) Inventor: MARC MAEDGEN, ROCKWALL, TX (US)

(21) Appl. No.: 19/560,872

(22) Filed: Mar. 9, 2026

Related U.S. Application Data
(60) Provisional application No. 63/768,313, filed on Mar. 7, 2025.

(51) Int. Cl. B62J 50/28; B62H 5/00

(52) U.S. Cl. CPC B62J 50/28; B62H 5/00

(57) ABSTRACT

A mounting assembly for a bicycle includes a plate member, a strip member, and a plurality of magnetic assemblies within the strip member. The plate member is coupled to the bicycle, the plate member being magnetic. The flexible strip member is configured to selectively couple to a front face of the plate member. The plurality of magnetic assemblies are included within the flexible strip member and are configured to releasably secure the flexible strip member to the plate member. The plurality of magnetic assemblies have a plurality of magnets within a hosing and are free to rotate within the housing. The flexible strip member is configured to flex between the plurality of magnetic assemblies and selectively apply a compressive force against the plate member. The amount of compressive force is adjusted by changing the distance between the plurality of magnetic assemblies against the plate member.

### CROSS REFERENCE TO RELATED APPLICATIONS

This application claims the benefit of an earlier filing date and right of priority to U.S. Provisional Application No. 63/768,313, filed 7 Mar. 2025, the contents of which is incorporated by reference herein in its entirety.

### BACKGROUND OF THE INVENTION

### 1. Field of the Invention

The present application relates to a locking device, and more particularly to a mounting assembly used to carry a lock on a bicycle.

### 2. Description of Related Art

Bicycles, and especially e-bikes, have become a popular means of transportation, fitness, and recreation around the world. However, one consistent challenge for e-bike users is the secure transportation of U-locks, which are essential for safeguarding the bike when left unattended. While U-locks provide high levels of security, they are often bulky and heavy, making them difficult to carry in backpacks or cargo racks without adding unnecessary weight and reducing storage space for other essential items.

The need for a secure U-lock is essential for protecting e-bikes, which are often left unattended in public spaces. However, carrying the lock is a major inconvenience for riders. The bulky and heavy nature of U-locks makes them challenging to transport, whether in a backpack, cargo rack, or other traditional methods of storage. These conventional storage solutions also limit the available space for other items like tools, water bottles, or personal belongings.

Moreover, securing the U-lock on the bike frame without interfering with bike operation or performance proves to be a difficult task. For mountain bikers, the terrain often involves rough trails where traditional lock mounting systems may not be as secure or practical. This creates a need for a more reliable, space-efficient solution that can securely hold the U-lock on the bike frame, ensuring the lock stays in place throughout the ride, even during rough or off-road conditions.

Although strides have been made, shortcomings remain. It is desired that a mounting assembly be provided to hold a locking device to various different types of bikes securely and efficiently.

### BRIEF SUMMARY OF THE INVENTION

It is an object of the present application to provide a mounting assembly for use with bicycles that allows for the proper and safe securement of locks and other objects to the frame of the bicycle. The assembly is configured to provide a mounting plate and a removable flexible strip member with the strip member configured to compress an object against the plate member. The strip member uses magnets to maintain contact.

It is a further object of the present application to permit adjustment of the compressive force through selective positioning of the magnets within the strip member.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a mounting assembly according to an embodiment of the present application.

FIG. 2 is a partially exploded front view of the mounting assembly of FIG. 1.

FIG. 3 is an enlarged rear view of a strip member in the mounting assembly of FIG. 2.

FIG. 4 is a side view of a plate member in the mounting assembly of FIG. 2.

FIG. 5 is a perspective view of the mounting assembly of FIG. 2 secured around a lock.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The bicycle locking assembly of the present application offers a unique solution by securely attaching a U-lock to the bike's (i.e. e-bike) lower frame post using rare-earth magnets embedded in a flexible rubber strip. This design allows the lock to remain firmly in place, even on rough or uneven terrain, while eliminating the need to carry the lock in a backpack or cargo rack. The magnets ensure that the lock stays securely attached without shifting during the ride. The assembly significantly enhances the rider's experience by freeing up valuable space for other items, while ensuring the lock remains easily accessible and securely stored. The flexible rubber strip can also be used to hold other items on the bike, offering versatility beyond simply storing the U-lock. The design is simple, efficient, and durable, providing a reliable solution to the common problem of carrying a bulky U-lock while maintaining the bike's functionality and the rider's comfort.

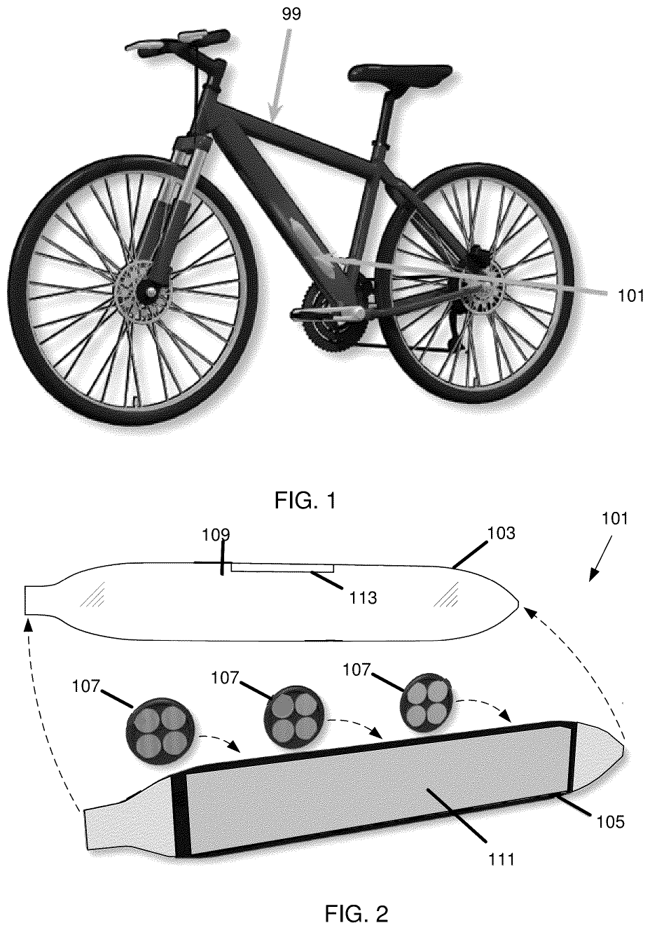

Referring now to FIG. 1 in the drawings, a perspective view of a mounting assembly for a bicycle is illustrated. Mounting assembly 101 is configured to be attached to a portion of a bicycle as illustrated in the Figures. Assembly 101 may be mounted in various different ways and methods including the use of adhesives, fasteners, or other attachment means. A simple example may be the use of a double-sided tape placed between the bicycle and assembly 101. It is understood that assembly 101 may include the attaching means which may be selected based upon the material of the bicycle frame. As seen in FIG. 1, bicycle 99 is shown with assembly 101 mounted to a lower portion of its frame adjacent to the pedal and sprocket assemblies. It is to be understood that this is not the sole location for assembly 101 to be mounted. It is meant to be an exemplary embodiment only. As stated previously, a purpose of mounting assembly 101 is to capture or securely hold a locking device used in association with bicycle 99 (see FIG. 5). Other uses for mounting assembly 101 are understood to exist beyond the locking device.

Referring now also to FIG. 2 in the drawings, a partially exploded front view of mounting assembly 101 is provided. Mounting assembly 101 includes a plate member 103, a strip member 105, and a plurality of magnetic assemblies 107. Plate member 103 is a rigidly formed material typically made from metal such as steel. It is understood that plate 103 may include any number of coatings or other such treatments to assist with minimizing corrosion or harming the frame of bicycle 99. In example may include a powder coat finish applied through an electrostatic spray and heat curing to enhance corrosion resistance and aesthetic appeal.

In operation, plate member 103 is aligned and situated in a desired orientation and location and is then adhered to or coupled to a portion of bicycle 99. Plate member 103 further includes a lip 113 formed along an outer edge of its body which is useful to assist and holding and or aligning strip member 105. Lip 113 may extend away from a front surface 109 any set distance, an example of which may be ⅛ of an inch.

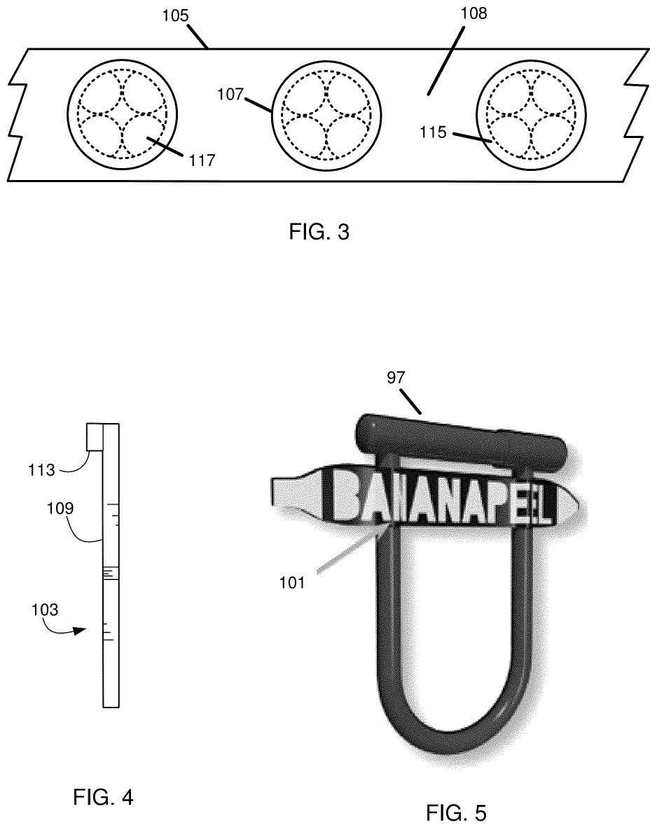

Strip member 105 is configured to be a flexible item of assembly 101 and may ideally be formed from a rubberized material that allows for durability and flexibility. In operation, a rear surface 108 (see FIG. 3) of strip member 105 is configured to contact with or abut a front surface 109 of plate 103. Strip member 105 further includes a plurality of magnetic assemblies 107 embedded into its rear surface 108 that are configured to selectively and releasably couple strip member 105 to front surface 109 of plate member 103. The flexible nature of strip member 105 allows its body to flex around objects between itself and plate member 103. This “flexing” applies a compressive force sufficient to hold those objects securely in place.

It is further understood that strip member 105 further includes a front surface 111 that is configured to receive graphical indicia which may include raised and lowered surfaces to generate lettering, logos, or other identification language and symbols. Such graphical indicia is configured to maintain the flexibility and durability of strip member 105 as a whole. Such graphical indicia may be formed into strict member 105 and therefore be made from the same material as its general body.

Strip member 105 may have a plurality of environmental treatments to provide inherent characteristics that allow it to be suitable for exterior use exposed to harmful elements. Strip member 105 may include UV resistant coating to prevent degradation from sun exposure. This may be applied through a dip coating process or other methods. The material of strip member 105 may include a durable elastomer compound such as EPDM or TPE (thermoplastic elastomer) to help with flexibility and weather resistance.

Referring now also to FIG. 3 in the drawings, a partial rear view of strip member 103 is illustrated. Rear surface 108 is shown with magnetic assemblies 107 embedded therein. Magnetic assemblies 107 include a housing 115 configured to capture and hold a plurality of magnets 117. Housing 115 is formed to include a cavity in which magnets 117 are configured to reside. Magnetic assemblies 107 thereby form magnetic clusters with magnets 117 that are free to move inside the cavity of housing 115. Encapsulating magnets 117 within housing 115 is important so as to help ensure the overall flexibility of assembly 101 as a whole.

It is understood that magnets 117 are shown as being visible in a rear view for clarity purposes, but that in some embodiments housing 115 may in fact cover or envelop magnets 117 so as to not be visible in the rear view. As noted previously, magnetic assemblies 107 are embedded into/or located on rear surface 108. It is to be further understood that magnets 117 may be made from rare earth metals to create strong and secure bonds with a locking device and plate member 103.

It is also understood that housing 115 is coupled directly within strip member 105. Although magnets 117 may be free to move within housing 115, the distance between individual housings 115 are set within strip member 105. However, in operation, when strip member 105 is placed upon or coupled to plate member 103, it is configured to secure various objects thereto. In doing so, the objects are captured between strip member 105 and plate member 103. To accommodate this, strip member 105 is flexible at least between locations of housings 115 to allow the flexible strip member body to wrap around the objects and apply a compressive force to them between when captured between strip member 105 and plate member 103.

It is to be understood that magnetic assemblies 107 are not required to only couple to a particular position on plate member 103, but in fact can couple to any position along the surface of plate member 103. This allows strip member 105 to accommodate different sized objects. For example, when no object is being secured, the distance between magnetic assemblies 107 may be maximized to allow a flat surface against plate member 103. To allow space for the object, strip member 105 flexes and the distance between magnetic assemblies 107 may decrease when coupled to plate member 103. In this way, the distance between magnetic assemblies 107 is not set and may in fact vary depending on the object size.

Referring now also to FIG. 4 in the drawings, a side view of plate member 103 is provided. The side view is useful to assist in capturing lip 113 Strip member 105 is configured to rest upon and or contact a portion of lip 113 in use. Lip 113 may also be useful in orienting and aligning member 105. The precise size of lip 113 is selected based upon design constraints. An exemplary size may be approximately 2 inches in length along the edge of plate member 103.

Referring now also to FIG. 5 in the drawings, a front perspective view of assembly 101 is illustrated in relation to locking device 97. As seen from the Figure, strip member 105 is configured to flex around locking device 97. Plate member 103 is situated behind strip member 105 and the magnetic assemblies 107 embedded within rear surface 108 adhere or bond strip member 105 to plate member 103. The spacing of magnetic assemblies 107 are configured to permit strip member 105 to conform around locking device 97. It is also worth noting that graphical indicia is illustrated along front surface 111 of strip member 105.

Mounting assembly 101 has been described in a manner to reflect its many uses and advantages. With plate member 103 ensuring a stable base in which strip member 103 may be releasably applied, many objects may be captured between them to ensure security and limited mobility for carrying. In use a user merely pulls strip member 105 away from plate member 103 and released the object being held. Magnetic assemblies 107 are configured to last indefinitely and not wear out as seen with overtime conventional adhesives. Additionally assembly 101 avoids the need to use latches or other mechanical fasteners which may wear and fail over time.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A mounting assembly for a bicycle, comprising:
a plate member coupled to the bicycle;
a flexible strip member configured to selectively couple to a front face of the plate member; and
a plurality of magnetic assemblies included within the flexible strip member and configured to releasably secure the flexible strip member to the plate member;
wherein the flexible strip member is configured to flex between the plurality of magnetic assemblies such that distance between the plurality of magnetic assemblies can be varied when coupled to the plate member.

2. The assembly of claim 1, wherein the plate member is adhered to the bicycle.

3. The assembly of claim 1, wherein the plate member is fastened to the bicycle.

4. The assembly of claim 1, wherein the plate member is magnetic.

5. The assembly of claim 1, wherein the plate member includes a lip to locate the flexible strip member.

6. The assembly of claim 1, wherein the flexible strip member includes graphical indicia.

7. The assembly of claim 1, wherein the plurality of magnetic assemblies are located at a rear surface of the flexible strip member.

8. The assembly of claim 1, wherein the flexible strip member includes at least one environmental treatment.

9. The assembly of claim 8, wherein the environmental treatment is a UV coating.

10. The assembly of claim 1, wherein the plurality of magnetic assemblies includes a housing containing a plurality of magnets, the flexible strip member coupled to the housing.

11. The assembly of claim 10, wherein the plurality of magnets are free to rotate and move within the housing.

12. The assembly of claim 1, wherein the flexible strip member is configured to apply a compressive force to the plate member, the amount of compressive force is adjusted by changing the distance between the plurality of magnetic assemblies against the plate member.

13. A mounting assembly for a bicycle, comprising:
a plate member coupled to the bicycle, the plate member being magnetic;
a flexible strip member configured to selectively couple to a front face of the plate member; and
a plurality of magnetic assemblies included within the flexible strip member and configured to releasably secure the flexible strip member to the plate member, the plurality of magnetic assemblies including a plurality of magnets within a hosing, the plurality of magnets being free to rotate within the housing;
wherein the flexible strip member is configured to flex between the plurality of magnetic assemblies and selectively apply a compressive force against the plate member.

14. The assembly of claim 13, wherein the plate member is adhered to the bicycle.

15. The assembly of claim 13, wherein the plate member is fastened to the bicycle.

16. The assembly of claim 13, wherein the plate member includes a lip to locate the flexible strip member.

17. The assembly of claim 13, wherein the flexible strip member includes graphical indicia.

18. The assembly of claim 13, wherein the plurality of magnetic assemblies are located at a rear surface of the flexible strip member.

19. The assembly of claim 13, wherein the flexible strip member includes at least one environmental treatment.

20. The assembly of claim 13, wherein the amount of compressive force is adjusted by changing the distance between the plurality of magnetic assemblies against the plate member.
